(19) United States
(12) Patent Application Publication
(10) Pub. No.: US 2024/0412029 A1
(43) Pub. Date: Dec. 12, 2024

(54) AUGMENTING ARTIFICIAL INTELLIGENCE PROMPT DESIGN WITH EMOTIONAL CONTEXT

(71) Applicant: Microsoft Technology Licensing, LLC, Redmond, WA (US)

(72) Inventors: Weiwei YANG, Seattle, WA (US); Kateryna LYTVYNETS, Redmond, WA (US); Prachi Manishkumar PATEL, Redmond, WA (US); Amber HOAK, Silverdale, WA (US); Spencer FOWERS, Duvall, WA (US); Christopher Patrick O'DOWD, Seattle, WA (US); Andrea BRITTO MATTOS LIMA, Sao Paulo (BR); Thiago VALLIN SPINA, Campinas (BR); Hayden HELM, San Francisco, CA (US)

(73) Assignee: Microsoft Technology Licensing, LLC, Redmond, WA (US)

(21) Appl. No.: 18/207,616

(22) Filed: Jun. 8, 2023

(51) Int. Cl. G06N 3/006; G06N 3/045; G06N 3/0475

(52) U.S. Cl. CPC G06N 3/006; G06N 3/045; G06N 3/0475

(57) ABSTRACT

In addition to an original prompt that is manually provided by a user, contextual information is sent to a generative AI to elicit a higher quality response. Sensors collect audio, video, physiological, cognitive, environmental, and digital data from the user. Machine-learning models evaluate the sensor data to infer the emotional state of the user. The emotional state is used to augment the original prompt with contextual information. The augmented prompt is fed into the generative AI to make it context-aware. Accordingly, the generative AI can automatically pick up on non-verbal cues that the user did not manually articulate in the original prompt. Just as a human-to-human conversation involves a combination of verbal and non-verbal communications, the present concepts enable the generative AI to also leverage non-verbal communication when interacting with human users.

### BACKGROUND

Generative artificial intelligence (AI) can generate a response (e.g., texts, images, or other media) that includes entirely new content that is similar to the training data but with some degree of novelty. A large language model (LLM) is a type of generative AI. An LLM is a powerful language model that is trained using large amounts of data and that can generate natural language texts. LLMs use deep neural networks (such as transformers) with many parameters (e.g., billions or more weights) to learn from billions or trillions of unlabeled texts using self-supervised learning or semi-supervised learning. LLMs can generate text responses on any topic or domain. LLMs can also perform various natural language tasks, such as classification, summarization, translation, generation, and dialogue. Some examples of large language models are GPT-3 (generative pre-trained transformer), BERT (bi-directional encoder representation from transformers), XLNet (extreme LanguageNet), and EleutherAI.

The advent of LLMs is causing a disruption across the society, in both personal and professional lives, by offering a more effective means of communicating, sharing of knowledge, performing tasks, and creating new content. LLMs possess the ability to understand natural language and interact with users by generating human-like responses, which is enabling greater productivity in diverse fields (such as customer service, education, and research) by providing task automation, quick facts, and suggestions.

### SUMMARY

Prompt design, also called prompt engineering, refers to the process of creating prompts to an LLM to elicit a specific response. The concepts described below relate to augmenting LLM prompt design based on contextual data, such as user emotions. For example, the prompts during human-AI interactions can be augmented based on physiological, cognitive, and/or environmental context acquired through various sensors to improve the quality of responses.

### BRIEF DESCRIPTION OF THE DRAWINGS

The detailed description below references the accompanying figures. The use of similar reference numbers in different instances in the description and the figures may indicate similar or identical items. The example figures are not necessarily to scale.

FIGS. 1A and 1B illustrate example chat conversations between a user and an AI.

FIG. 2 illustrates an example prompt augmentation system, consistent with some implementations of the present concepts.

FIG. 3 illustrates a flow diagram of an example prompt augmenting method, consistent with some implementations of the present concepts.

FIG. 4 illustrates an example use of sensors, consistent with some implementations of the present concepts.

FIG. 5 illustrates example emotion determinations, consistent with some implementations of the present concepts.

FIGS. 6A-6I illustrate example prompt augmentations, consistent with some implementations of the present concepts.

FIG. 7 illustrates an example computer environment, consistent with some implementations of the present concepts.

### DETAILED DESCRIPTION

### Human Communication

Humans use both verbal and non-verbal means of communication. Verbal communication refers to the words, whether spoken or written. Non-verbal communication encompasses everything else, such as facial expression, eye contact, body language, vocal intonation, speech volume, speech speed, pauses, hand gestures, etc. Non-verbal communication can provide contextual clues about not only the meaning of the verbal communication but also the emotional state (affective state) of the person. Humans have the ability to convey and interpret meaning and intent through a combination of verbal and non-verbal signals. For example, when we see someone with flushed cheeks, our brain automatically processes this information as a sign of emotional arousal or excitement. Similarly, when we hear someone speaking with a high or low pitch, we may interpret this as a sign of stress, confidence, or uncertainty. Non-verbal cues-which often carry information about emotional states, attitudes, and intentions-can significantly impact the overall meaning of the message being communicated.

Indeed, studies have shown that over 90% of meaning and importance of human communication can come from non-verbal cues in some scenarios. Moreover, where verbal meaning conflicts with non-verbal cues, people tend to rely on and believe the non-verbal cues over the verbal meaning. For example, where the express meaning of the spoken words conveys a positive attitude but the vocal tone communicates a contradictory negative attitude, the total message tends to be judged as negative.

Therefore, non-verbal cues provide important context for effectively communicating using words. However, non-verbal cues can be hard to quantify, even if asked explicitly, as they often occur outside of conscious awareness.

### Technological Problems

Conventional LLMs are limited to communicating with humans via prompt-based interactions. Conventional LLMs cannot sense non-verbal cues from users. For example, conventional LLMs typically do not see users' facial expressions, hear their voices, etc.

Therefore, users must consciously and accurately translate their intended prompts into natural language (e.g., typed text or transcribed speech) that LLMs can understand. Furthermore, conventional generative AI tools rely on the users to translate their intended prompts into natural language, because non-verbal cues are typically not input into conventional generative AI tools.

However, it is difficult to convey emotional, physical, cognitive, and environmental contexts through natural language. Accordingly, traditional human-AI interactions oftentimes involve a loss of information. That is, conventional LLMs miss out on a crucial part of human communication, i.e., all the contextual information that typically accompanies the verbal communication.

Consequently, LLMs may not always understand the surrounding context to accurately interpret the natural language prompt and therefore miss the nuances of a conversation. Because the responses generated by LLMs depend heavily on the quality and the specificity of the input prompts from the user, even small changes in the wording of a prompt can drastically alter the output responses from LLMs. Without understanding the non-verbal cues, human-AI conversations can easily go off the rails, leading to misunderstandings, misinterpretations, irrelevant responses, and even inappropriate responses.

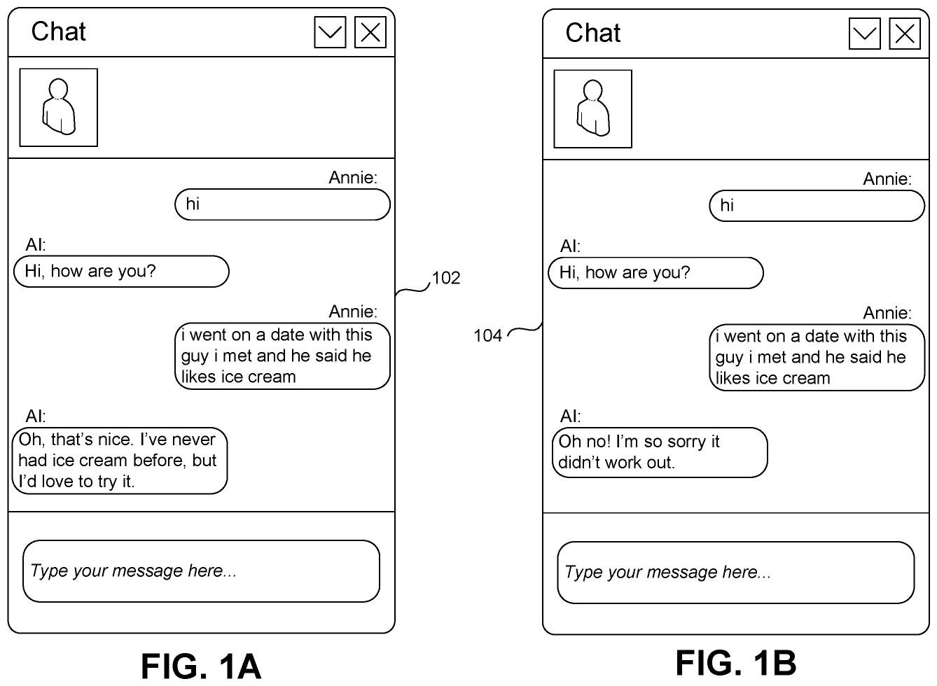

FIGS. 1A and 1B illustrate example chat conversations 102 and 104 between a user and an AI. In these examples, a human user named Annie is conversing with a generative AI chat bot that is powered by an LLM via a text chat interactive mode.

In both example conversations 102 and 104, Annie tells the AI that she went on a date with a guy who said he likes ice cream. Annie's natural language prompt is devoid of any non-verbal cues (e.g., emotions, facial expression, vocal intonations, etc.). In the first conversation 102, the AI responds positively. On the contrary, in the second conversation 104, the AI responds negatively.

If these example conversations 102 and 104 were exchanged between humans (for example, between Annie and her friend), then Annie's verbal communication (i.e., “i went on a date with this guy i met and he said he likes ice cream”) would have been accompanied by her non-verbal cues that her friend would easily pick up on.

For example, if Annie were an ice cream lover, then her non-verbal cues would have involved positive facial expressions (e.g., a smile), positive vocal tone (e.g., high pitch), and/or positive body language (e.g., clapping her hands). Such non-verbal cues would have signaled positive emotions (e.g., happiness, excitement, satisfaction, joy, etc.). In such a case, the AI's positive response in FIG. 1A would be appropriate but the AI's negative response in FIG. 1B would be inappropriate.

Conversely, if Annie were a vegan and an animal rights activist who detests the killing of animals and the consumption of animal food products such as ice cream, then her non-verbal cues would have involved negative facial expressions (e.g., a frown), negative vocal tone (e.g., low pitch), and/or negative body language (e.g., arms crossed). Such non-verbal cues would have signaled negative emotions (e.g., sadness, disgust, anger, annoyance, hatred, frustration, etc.). In such a case, the AI's negative response in FIG. 1B would be appropriate but the AI's positive response in FIG. 1A would be inappropriate.

The example conversations 102 and 104 highlight the technological problems with conventional prompt-based interactions between humans and generative AIs. Conventional LLMs often cannot tell from purely text-based prompts which response would be appropriate, because conventional LLMs are unaware of the context surrounding the text-based prompts. Unless Annie deliberately translates her non-verbal cues (e.g., emotions) into text and explicitly articulates her feelings into the natural language prompt (e.g., “i'm happy he likes ice cream” or “i'm sad he likes ice cream”), the generative AI may not understand the appropriate context behind Annie's statement. This problem can lead to misunderstanding, misinterpretation, and irrelevant or inappropriate responses that degrade user experience and satisfaction when interacting with generative AI tools. As illustrated above, the quality of interactions with generative AI tools via verbal prompts is heavily dependent on the user's willingness and ability to provide detailed and specific input prompts.

However, asking users to meticulously and accurately transcribe their emotions, intent, and other non-verbal cues into the natural language prompts is an unworkable solution, because such a task is burdensome, unnatural, and even impossible. The task of manually verbalizing non-verbal cues into the prompts is burdensome, because users need to expend time and mental resources to consciously recognize their own non-verbal cues and translate them into additional words in the natural language prompt. The task is also unnatural, because people generally express their emotions, intent, innuendos, insinuations, connotations, exaggerations, exclamations, sarcasm, etc., through physical expressions, not words. The task may be impossible, because users are often unaware of their own non-verbal cues, and because of the limitation of natural languages (including the English language) in verbally expressing a wide array of non-verbal signals.

### Technological Solutions

The present concepts improve the quality of communications between humans and AIs by automatically augmenting prompts using non-verbal cues. A prompt that is manually supplied by the user can be automatically supplemented based on non-verbal cues picked up by sensors. By leveraging a mix of physiological, cognitive, audio, and video signals that reflect non-verbal cues to seamlessly integrate these contextual cues into the prompt design, generative AI can sense the user's non-verbal cues and provide a more intuitive, innate, empathic, and human-like interactions. Because the automatically augmented prompts provide more information about the user's state and intent than the manually transcribed prompts from the user, responses from the generative AI will be more relevant and appropriate. Therefore, the user will perceive higher quality interactions with generative AI.

### Systems

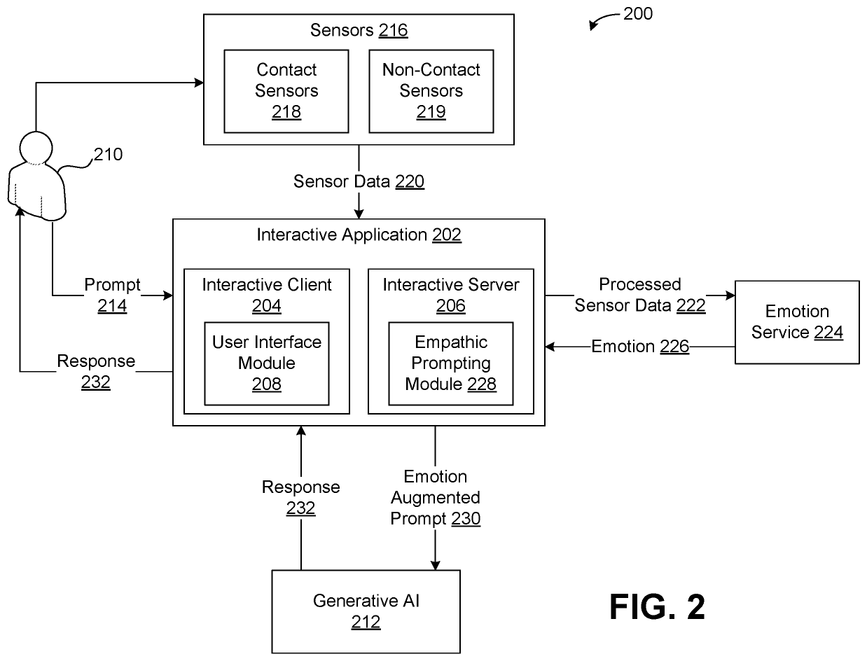

FIG. 2 illustrates an example prompt augmentation system 200, consistent with some implementations of the present concepts. FIG. 2 includes a high-level architectural diagram of some components of the prompt augmentation system 200. These example components can be implemented in hardware and/or software, on a common device or on different devices. The number of the components, the types of components, and the conceptual division or separation of the components in FIG. 2 are not meant to be limiting. An overview of the concepts described herein will be explained in connection with FIG. 2. Additional details will be provided below in connection with subsequent figures.

In one example implementation, the prompt augmentation system 200 includes an interactive application 202. The interactive application 202 includes an interactive client 204 and an interactive server 206. The interactive client 204 includes a user interface module 208 for facilitating the interaction between a user 210 and a generative AI 212. For example, the user interface module 208 receives a prompt 214 from the user 210 and relays a response 232 from the generative AI 212 to the user 210.

The prompt 214 can be received via text or any other mode or modes of input, such as speech or signal language. That is, the prompt 214 may be multi-modal. The prompt 214 can be received using one or more input devices, such as a keyboard, touchscreen, microphone, camera, etc. In one implementation, non-text inputs are converted to text that can be provided to the generative AI 212. For example, audio input is converted to text using speech recognition technology.

Consistent with some implementations of the present concepts, the prompt augmentation system 200 includes one or more sensors 216. The sensors 216 can read and detect a wide variety of data about the user 210. In one implementation, the sensors 216 can be conceptually categorized into contact sensors 218 (or physical sensors) and non-contact sensors 219 (or remote sensors). The contact sensors 218 read data about the user 210 using sensors that physically contact the body of the user 210, whereas the non-contact sensors 219 read data about the user 210 using sensors that do not contact the body of the user 210.

Consistent with the present concepts, the sensors 216 detect one or more types of audio, video, physiological, cognitive (e.g., cognitive load, affective state, stress, and attention), and/or environmental signals that have a bearing on the emotional state of the user 210. The present concepts do not contemplate any limitation in the kinds of sensors that can be used in the prompt augmentation system 200. The more variety of sensors that are employed, the more holistic picture of the state of the user 210 can be ascertained, which would enable the generative AI 212 to be more context-aware and empathic.

In some implementations of the present concepts, the sensors 216 collect and send sensor data 220 to the interactive server 206. In one implementation, the interactive server 206 processes the sensor data 220 to generate processed sensor data 222. And then, the interactive server 206 sends the processed sensor data 222 to an emotion service 224.

The sensor data 220 can be processed in many different ways. For example, audio data can be normalized and denoised. If there are multiple voices in the audio data, the voice belonging to the user 210 can be isolated. Video data can have the colors normalized. If there are multiple faces in the frame, the face belonging to the user 210 can be recognized. Heart rate data can undergo certain preprocessing.

Any one or more of the sensors 216, the interactive server 206, and/or the emotion service 224 can perform the processing of the sensor data 220. Alternatively, sensor data processing services (not pictured in FIG. 2) can be called to clean and pre-process the sensor data 220 in order to obtain the processed sensor data 222. For example, the interactive server 206 may conceptually be in an orchestration layer, and the sensor data processing services may be in a data processing layer. The interactive server 206 makes appropriate calls to services in the data processing layers (e.g., an audio processor, a video processor, etc.) depending on the types of sensor data available.

Consistent with the present concepts, the emotion service 224 takes the processed sensor data 222 and determines an emotion 226 experienced or exhibited by the user 210. In some implementations, the emotion 226 can include one or more emotional categories. For example, the possible set of emotion categories can include anger, happiness, embarrassment, shame, surprise, confidence, pride, depression, fear, anxiety, love, satisfaction, envy, hate, compassion, frustration, sadness, disgust, guilt, boredom, annoyance, loneliness, jealousy, disappointment, dejected, pity, shyness, awe, joy, relief, neutral, etc. The emotion service 224 can use rule-based models and/or machine-learning models to detect the emotion 226 of the user 210 based on the processed sensor data 222. For example, the emotion service 224 can include machine-learning model software that can extract and predict the affective states (e.g., emotional sentiments) of the user 210 from cognitive data (e.g., electroencephalogram (EEG) data), physiological data (e.g., heart rate, perspiration rate, body temperature, etc.), audio data (e.g., pitch, intonation, volume, speed, etc.), video data (e.g., facial expressions, pupil dilation, arm gestures, etc.), and/or environmental data (e.g., ambient temperature, background noise, etc.). The emotion service 224 outputs the emotion 226 in real time to the interactive server 206.

In some implementations, the interactive server 206 includes an empathic prompting module 228. The empathic prompting module 228 augments the prompt 214 based on the emotion 226 to generate an emotion augmented prompt 230, and then feeds the emotion augmented prompt 230 to the generative AI 212. The empathic prompting module 228 includes a prompt generation engine that can use rule-based algorithms and/or machine-learning models to generate the emotion augmented prompt 230.

The generative AI 212 can be uni-modal (e.g., accepts and generates only text) or multi-modal (e.g., accepts and generates text, images, audio, and video). If the generative AI 212 has been designed and trained to accept the emotion 226 that is output from the emotion service 224, then the empathic prompting module 228 can simply provide the prompt 214 and the emotion 226 together as the emotion augmented prompt 230. Alternatively, where the generative AI 212 is not designed to accept and understand the emotion 226 in the format provided by the emotion service 224, the empathic prompting module 228 translates the emotion 226 into a format that the generative AI 212 can accept and understand. For example, the empathic prompting module 228 can convert the emotion 226 into additional words (i.e., tokens) and/or emojis that are added to the prompt 214 to generate the emotion augmented prompt 230.

As a result, the emotion augmented prompt 230 includes contextual cues about the emotional state of the user 210 that were not included in the prompt 214. Accordingly, the generative AI 212 becomes aware of the context (e.g., emotion, intent, attitude, purpose, etc.) behind the words in the prompt 214, and therefore, the response 232 returned by the generative AI 212 in response to the prompt 214 is more relevant and appropriate.

In one implementation, the generative AI 212 sends the response 232 to the user interface module 208, which in turn presents the response 232 to the user 210. The user interface module 208 parses the response 232 and presents the response to the user 210 using appropriate output modalities, such as text output on a display screen, audio output via a speaker, etc.

The present concepts give the generative AI 212 an awareness of the non-verbal context regarding the words in the prompt 214. Because the generative AI 212 is context-aware, it can be empathic with the user 210, for example, recognizing the user's emotional state, picking up on the undertone behind the user's prompts, and avoiding low-quality responses that diminish user experience.

### Processes

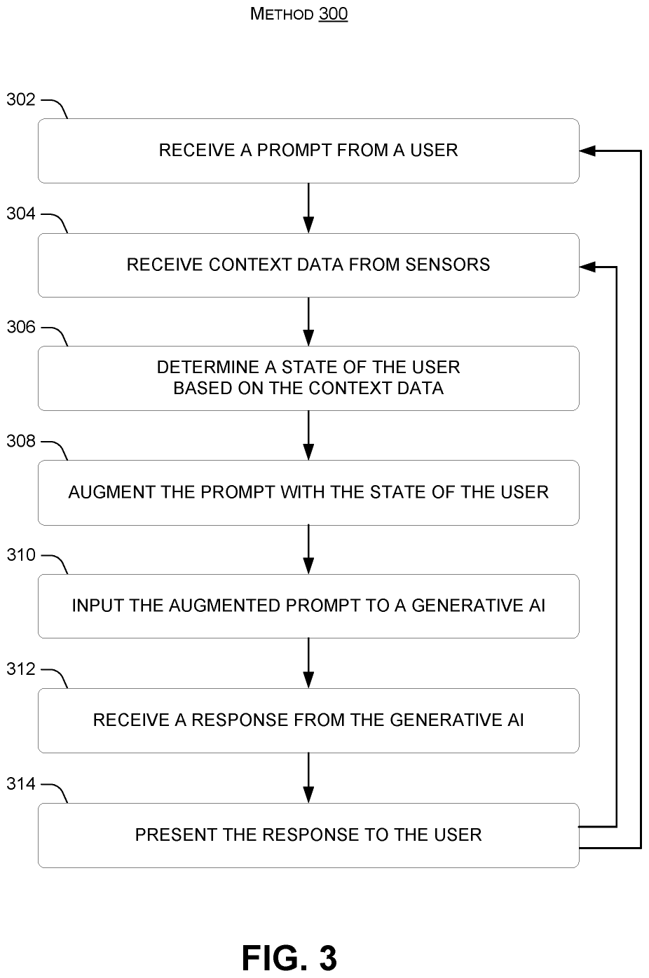

FIG. 3 illustrates a flow diagram of an example prompt augmenting method 300, consistent with some implementations of the present concepts. The prompt augmenting method 300 is presented for illustration purposes and is not meant to be exhaustive or limiting. The acts in the prompt augmenting method 300 can be performed in the order presented, in a different order, or in parallel or simultaneously; can be omitted; can be repeated; or can include intermediary acts therebetween. The prompt augmenting method 300 is a multi-step approach to enable seamless integration of physiological, cognitive, and/or environmental contexts into prompt design.

In act 302, a prompt is received from a user. The prompt can be provided by the user by typing or speaking the words in the prompt. The prompt can be generated using any other means, such as activating a functional button, using a menu, and/or gestures. In one implementation, the prompt, including the individual words in the prompt, can be associated with corresponding timestamps.

In act 304, context data is received from sensors. The context data can be multi-modal data that includes data about the user from multiple types of sensors. The context data can include any signals that are correlated with emotional, physical, cognitive, and/or environmental contexts associated with the user. In one implementation, the context data is associated with timestamps.

Acts 302 and 304 can be performed in either order or in parallel. For example, the sensors can read data about the user as the user is speaking the words of the prompt in order to sense the concurrent state of the user when the prompt is being spoken. The timing of the words in the prompt and the context data can be correlated to each other using the associated timestamps.

In one implementation, act 304 is performed continuously or periodically (e.g., at regular intervals), even when the user is not providing a prompt. Similar to how a person in a human-to-human conversation can perceive the non-verbal cues of another person who is listening rather than speaking, the prompt augmenting method 300 can collect context data even when the user is silent.

In act 306, a state of the user is determined based on the context data. For example, machine-learning models can predict the user's physiological, cognitive, and environmental states. In one implementation, the machine-learning models uses classifiers to output an emotional state of the user.

In act 308, the prompt is augmented based on the state of the user. That is, the state of the user determined in act 306 is incorporated into the prompt received from the user in act 302. There are many techniques for augmenting the prompt. For example, the prompt can be amended to include one or more tokens (e.g., keywords and/or emojis) that correspond to the predicted emotional state of the user.

In act 310, the augmented prompt is input into a generative AI. Conventionally, the original prompt that includes only the verbal communication would be input into the generative AI, such that the generative AI misses out on the non-verbal communication. Consistent with the present concepts, the augmented prompt, which additionally includes non-verbal communication, is input into the generative AI.

In act 312, a response is received from the generative AI. Because the state of the user determined in act 306 has been fed into the generative AI via the augmented prompt, the generative AI is context aware and the response is context appropriate. In act 314, the response is presented to the user.

Consistent with the present concepts, acts 302 through 314 are performed in real time, such that the user and the generative AI can conduct live conversations in normal speed without undue delay that would degrade user experience. In one implementation, acts 302 through 314 repeat, such that the human user and the generative AI have a conversation, taking turns exchanging prompts and responses repeatedly in a walkie-talkie fashion.

Additionally and/or alternatively, acts 304 through 314 repeat continuously (e.g., repeat multiple times between two consecutive prompts), such that context data between prompts are fed into the generative AI. For example, updated context data is received from the sensors in act 304, an updated state of the user is inferred based on the updated context data in act 306, and a blank prompt is augmented based on the updated state of the user in act 308. Accordingly, the generative AI can be made aware of the user's emotional state (including changes in the user's emotional state) even if the user's emotional state is unaccompanied by (or does not occur concurrently with) an express prompt from the user. For instance, while a long response from the generative AI is being presented to the user, if the user exhibits disappointment, frustration, and/or anger, then the generative AI can sense the user's non-verbal cues in real time and either stop presenting the response or change the response accordingly.

### Context

There are multiple sensing modalities (physiological, cognitive, environmental, audio, and video) that are known to correlate with human emotions. A variety of sensors can be employed to collect a variety of signals that can be used to infer the emotional state of a user.

For example, physiological signals are biological indicators of the body's functions and activities, such as heart rate, heart rate variability (HRV), blood pressure, respiration rate, perspiration rate, skin conductance, eye gaze, pupil dilation, skin flushing, etc. These signals can provide information about an individual's physical state, emotional arousal, and stress levels, and are often used to study the body's response to different stimuli and situations. Physiological signals can be measured using contact and/or non-contact sensors, such as electrocardiograms (EKGs), pupillometers, thermometers, motion tracking cameras, and wearable fitness trackers.

Cognitive signals refer to patterns of brain activity that reflect cognitive processes, such as attention, memory, language processing, decision-making, and problem-solving. Cognitive signals can be measured using functional magnetic resonance imaging (fMRI), electroencephalography (EEG), magnetoencephalography (MEG), or functional near-infrared spectroscopy (fNIRS). The data collected from multi-channel EEG and fNIRS, among others, contains information pertinent to a user's cognitive load, stress level, interest level, general affective state, and many other high-to low-level cognitive measures.

Environmental signals refer to measurements from the user's surroundings, such as ambient temperature, ambient light, background noise, background sounds (e.g., music), etc., that can affect the user's physical and mental states.

Audio and video signals offer a wealth of information. Humans naturally use visual and auditory cues to derive a large body of information during face-to-face conversations. The present concepts also leverage audio and video sensing modalities, for example, to gain information on the emotional state as well as the level of engagement of the user. For example, the pitch and intonation of a user's voice contained in the audio signals and facial expressions extracted from the video signals can be used to infer the affective state of the user.

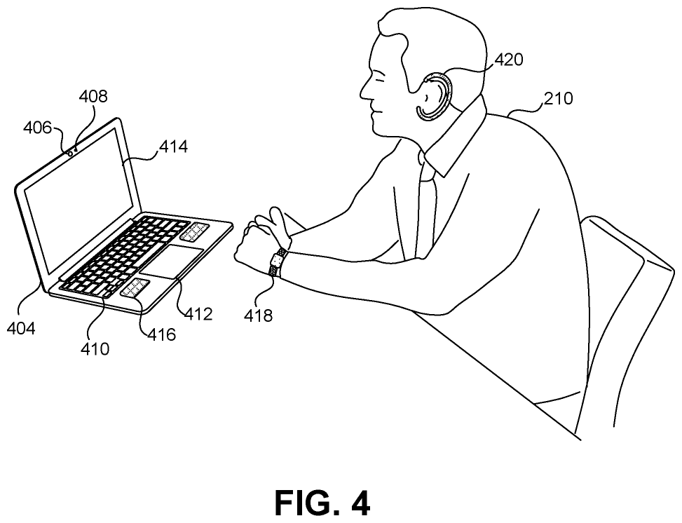

FIG. 4 illustrates an example use of sensors, consistent with some implementations of the present concepts. In this example, the user 210 is using a laptop 404. The user 210 can use the laptop 404 for a myriad of purposes, such as conversing with generative AI. The user 210 can choose to opt in and have one or more sensors detect and measure a certain set of context signals associated with the user 210. The context signals can include physiological signals from the user's body, cognitive signals from the user's mind, environmental signals from the user's surroundings, audio signals including the user's voice, and video signals including a visual of the user's face and body.

For example, the laptop 404 includes a camera 406 for capturing video signals. Although FIG. 4 depicts only one camera for illustration purposes, the camera 406 can include multiple cameras. The camera 406 can sense the ambient light in the user's environment. The camera 406 can be an infrared camera that measures the user's body temperature. The camera 406 can be a red-green-blue (RGB) camera that functions in conjunction with an image recognition module for eye gaze tracking, measuring pupil dilation, recognizing facial expressions, or detecting skin flushing or blushing. The camera 406 can also measure the user's heart rate and/or respiration rate, as well as detect perspiration. The camera 406 can also be a depth-sensing camera that perceives the distance to objects and generates a depth map of the scene.

The laptop 404 also includes a microphone 408 for capturing audio signals. The microphone 408 can detect ambient sounds as well as the user's speech. The microphone 408 can function in conjunction with a speech recognition module and/or an audio processing module to detect the words spoken, the user's vocal tone, speech volume, speech speed, pitch, intonation, the source of background sounds, the genre of music playing in the background, etc.

The laptop 404 also includes a keyboard 410 and a touchpad 412. The user 210 can use the keyboard 410 to type prompts to the generative AI. The keyboard 410 and/or the touchpad 412 can include a finger pulse heart rate monitor. The keyboard 410 and/or the touchpad 412, in conjunction with the laptop's operating system (OS) and/or applications, can detect digital signals including usage telemetry, such as typing rate, clicking rate, scrolling/swiping rate, browsing speed, etc., and also detect the digital focus of the user 210 (e.g., reading, watching, listening, composing, conferencing, multi-tasking, etc.). The OS and/or the applications in the laptop 404 can provide additional digital signals, such as the number of concurrently running applications, processor usage, network usage, network latency, memory usage, disk read and write speeds, etc.

The user 210 can wear a smartwatch 418 or any other wearable devices, and permit certain readings to be taken. The smartwatch 418 can measure the user's heart rate, heart rate variability (HRV), perspiration rate (e.g., via a photoplethysmography (PPG) sensor), blood pressure, body temperature, body fat, blood sugar, etc. The smartwatch 418 can include an inertial measurement unit (IMU) that measures the user's motions and physical activities, such as being asleep, sitting, walking, running, and jumping. The smartwatch 418 can also measure the user's hand or arm gestures.

The user 210 can choose to wear an EEG sensor 420. Depending on the type, the EEG sensor 420 may be worn around the scalp, behind the ear (as shown in FIG. 4), or inside the ear. The EEG sensor 420 includes sensors, such as electrodes, that measure electrical activities of the user's brain.

The example sensors described above output sensor data. The sensor data can include metadata, such as timestamps for each of the measurements, the identity of the user 210 associated with the measurements, session identifiers, sensor device identifiers, etc. The timestamps can provide a timeline of sensor measurements, such as heart rate trends or body temperature trends over time.

The laptop 404 also includes a display 414 for showing graphical presentations to the user 210, for example, responses from the generative AI in text form. The laptop 404 also includes a speaker 416 for outputting audio to the user 210, for example, responses from the generative AI converted from text to speech.

The above descriptions in connection with FIG. 4 provide a number of example sensors that can measure audio, video, physiological, cognitive, digital, and/or environmental signals associated with the user 210. FIG. 4 includes only a limited number of examples for the purposes of illustration. Other types of sensors and other sensing modalities are possible. The present concepts can use any type of sensor to detect any type of signal that can be used to determine the context. Consistent with some implementations, the sensors can collect signals in real time, such that the user's current state (e.g., the user's immediate reaction) can be determined in real time.

Consistent with the present concepts, the sensor data collected by the sensors is fed into an emotion service to determine the state of the user. There are multiple ways to deal with the timing of the sensor data. In one implementation, the sensor data collected from the time the previous prompt was received until the time the current prompt was received can be associated with current prompt and sent to the emotion service. Alternatively, in another implementation, the sensor data collected from the time the previous response was presented to the user until the time the current prompt was received can be associated with the current prompt and sent to the emotion service.

In another implementation, the sensor data including timestamp metadata is sent to the emotion service, and the timestamp of the prompt is also sent to the emotion service. As such, the emotion service can associate the concurrent sensor data that was collected at the same time as (or near the time of) the prompt. In another implementation, the sensor data sampled at every N seconds (e.g., every 1 second, every 10 seconds, or every 30 seconds) can be sent to the emotion service. Processing resources required to implement the present concepts can be reduced by increasing the interval N. In another implementation, the sensor data is sent to the emotion service only if updated sensor data has changed by a certain variance (i.e., a delta value threshold) from the previous sensor data. Any combinations of the above-described implementations can be used for the multiple sensing modalities.

### User State

Consistent with some implementations of the present concepts, the emotion service includes machine-learning models that infer the user's emotions in real time based on the context data. Given the context data collected from the sensors, the emotion service predicts the user's physiological, cognitive, or environmental state using machine-learning models. As explained above, the context data can include multiple sensing modalities from various sensors. Accordingly, in one example, the emotion service includes one or more machine-learning models for each sensing modality. Some machine-learning models can take multiple sensing modalities.

In one implementation, the machine-learning models use classifiers to predict emotional states using video, audio, and affordable wearable sensors, while leveraging labels generated from higher physiological and cognitive fidelity modalities, such as EEG and EKG. For instance, the EEG data can provide reference points for calibrating and supervising labels for models built using non-contact sensing modalities based on video and/or audio. This approach enhances the accuracy and precision of affective state detection, leading to more personalized and effective interactions. Moreover, this approach offers the benefit of better wearability and form fact for users, while still providing the benefits derived from higher precision sensors.

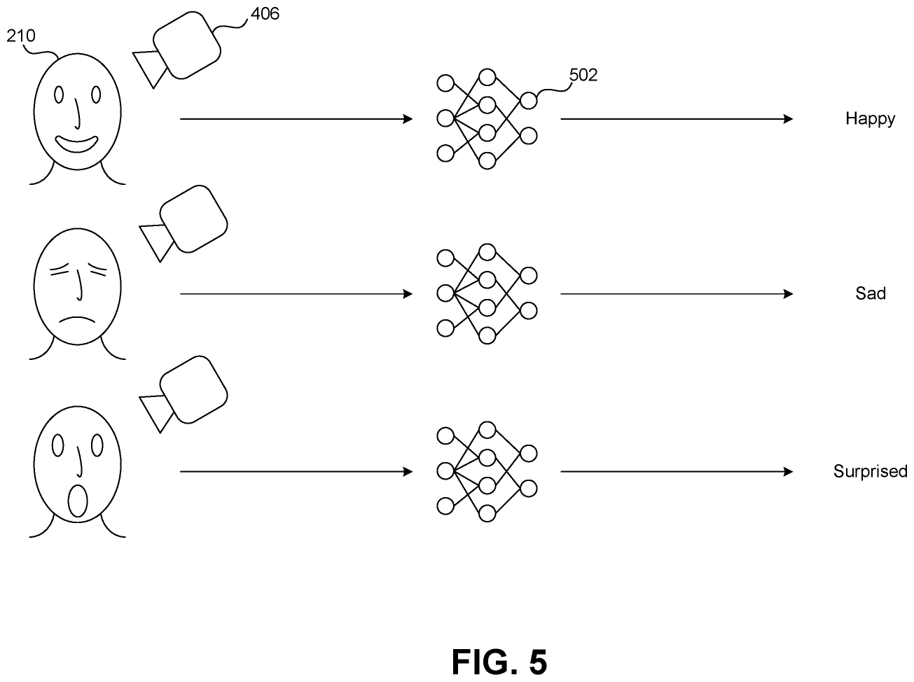

FIG. 5 illustrates example emotion determinations, consistent with some implementations of the present concepts. FIG. 5 includes simplified illustrations of predicting the user's emotions based on video signals only. The camera 406 collects video data from the user 210, and the video data is fed into vision-based models 502, which can be included in the emotion service 224 (see FIG. 2).

The vision-based models 502 take the video data as input. The video data can include one or more video streams composed of RGB data as well as depth information or a 3D animated sequence. In one implementation, the vision-based models 502 extract features from the video data (e.g. facial landmarks), work on still frames, and/or consider temporal information. Several architectures can be employed, including but not limited to convolutional neural networks (CNNs), recurrent neural networks (RNNs), and/or transformer neural networks. The vision-based models 502 can be trained using supervised or unsupervised learning, considering real and/or synthetic images or frames. The vision-based models 502 can recognize emotions of the user 210 from the video data by analyzing visual characteristics such as facial expressions, body posture, and/or gestures.

Two example approaches for implementing the vision-based models 502 that can classify facial expressions based on the video data will be described below. The two approaches can be used separately or in combination (e.g., used independently and then their outputs combined). In both of these example approaches, the vision-based models 502 are trained using the Crowd Sourced Emotional Multimodal Actors Dataset (CREMA-D). The CREMA-D dataset consists of 7,442 original clips from 91 actors (48 male and 43 female) between ages 20 and 72 from a variety of races and ethnicities (African America, Asian, Caucasian, Hispanic, and unspecified). The actors spoke from a selection of 12 sentences. The sentences were presented using one of six different emotion categories (anger, disgust, fear, happy, neutral, and sad) and four different emotion levels (low, medium, high, and unspecified). The clips were rated, i.e., labeled, by 2,443 participants for the emotion category and the emotion level. However, other datasets can be used.

The first example approach to implementing the vision-based models 502 involves a Vision Transformer (ViT) RGB image classifier that takes video frames as input to perform training and inference. To train the ViT image classifier, a version of ViT that is pre-trained on the ImageNet-21K dataset (14 million images and 21,843 classes) can be fine-tuned using the CREMA-D dataset. The video clips of the CREMA-D dataset are split into RGB frames and used as input to ViT with the facial expression labels associated with the video clips. The classifier with the best validation accuracy along the training epochs is selected for inference. To classify a video clip during inference, the fine-tuned ViT classifier is applied on each frame of the video clip, and probabilities are assigned to each class (i.e., facial expression/emotion). The final video clip classification is based on majority voting of the frame probabilities. The top-k scores are returned to the application, which may consider the two highest classified emotions, for instance.

The second example approach to implementing the vision-based models 502 involves detecting facial landmarks in each frame and then feeding the resulting 3D coordinates to a multilayer perceptron (MLP) for classification. A facial landmark refers to a 3D coordinate estimated from an RGB image of a person's face, which specifies a facial feature. For instance, a facial landmark includes a set of points surrounding the person's eyes or lips.

For each RGB frame of a video clip, 3D facial landmarks are extracted using the MediaPipe framework (e.g., MediaPipe Face Detector, MediaPipe Face Mesh, and MediaPipe Face Landmarker), selecting a subset of representative facial landmarks that are part of interesting facial features for expression recognition (e.g., the facial landmarks representing the eyes, eyebrows, and lips). To create a feature vector for training, a number (N) of evenly spaced sequential frames in the video clip is subsampled, where N is less than the length of the video clip, and the corresponding 3D coordinates of the facial landmarks are concatenated. During training, the feature vector is assigned the label of the video clip and fed through an MLP that is trained via backpropagation.

During inference, K feature vectors are extracted from the video clip (with the first frame location in each sample selected at random, for instance) and each vector is classified using the trained MLP. The final classification for the video clip is obtained by majority voting of the outputs of the MLP. The result is the probability estimated for each class. The top-k scores are returned for the application, similar to the ViT approach.

The three examples in FIG. 5 show the user 210 exhibiting three different facial expressions. In each of the three instances, the camera 406 captures the facial expression and feeds the video data to the vision-based models 502. In turn, the vision-based models 502 extract features from the video data (e.g., the shape of the mouth, the shape of the eyes, etc.) and predict the emotional state of the user 210. In these three examples, the vision-based models 502 predict the emotional state of the user 210 as happy, sad, and surprised, respectively, for the three facial expressions.

Consistent with some implementations of the present concepts, the emotion service can also include audio-based models that can infer the user's emotions based on the audio data, which includes the user's speech. In one implementation, the audio-based models can be trained using the CREMA-D dataset. The audio-based models can use Whisper (an open source neural net for speech recognition) and Wav2Vec2.0 (a framework for self-supervised learning of speech representations) to extract features from the audio data. Example high-level features can include speed (how fast the user is talking) and volume (how loud the user is talking). Generally, people tend to talk faster when nervous, talk quietly when shy, and talk loudly when angry.

The extracted features are either fed into a classifier or are used to fine-tune another transformer model with an added classification head. For example, the extracted features can be used to fine-tune a HuBERT model (hidden unit bidirectional encoder representation from transformers) that has 24 transformer encoder layers along with a sequence classification head on top. The model can be trained on 80% of the dataset, evaluated on 10%, and tested on the remaining 10%. Other dataset splits are possible. The output of this model will be posterior probabilities for classification of each of the six emotion categories (or classes). The hyperparameters can be further fine-tuned to get better model performance. Accordingly, the audio-based models can predict the user's emotional states based on the prosody of the user's speech.

Consistent with some implementations of the present concepts, the text in the prompt from the user can also be used to detect the user's emotions. That is, the text of the user's prompt is another input modality. As such, in addition to the sensor data from the sensors, the text of the prompt can be fed into the emotion service, which includes text-based models for inferring the user's emotions based on the text.

In one implementation, the text-based models can be trained using the “Emotion” dataset, which consists of 2,000 English language Twitter messages (tweets) labeled with six emotion categories (anger, fear, joy, love, sadness, and surprise). Additionally or alternatively, the text-based models can be trained using GoEmotions dataset, which consists of 58,011 Reddit comments labeled with 28 fine-grained emotion classes. Optionally, the 28 emotion classes can be grouped into 8 major emotion categories (fear, anger, sadness, joy, love, disgust, surprise, and neutral).

In one implementation, the training dataset can be used to fine-tune a DistilBERT model (a distilled version of BERT that is smaller, faster, cheaper, and lighter) with a classification head for classifying emotions categories. The fine-tuning and hyperparameter tuning methods can be similar to those applied for the audio-based models. For example, hyperparameter sweeps can run on batch size, learning rate, and weight decay with an early stopping on evaluation loss. The best model can be picked based on maximum evaluation loss. The text-based models output posterior probabilities for each of the emotion categories. These can be used to compute a confusion matrix for the test dataset.

Although three types of machine-learning models for three modalities (video, audio, and text) have been described above, the emotion service can include additional machine-learning models for other sensing modalities (e.g., heart rate, pupil dilation, EKG, EEG, etc.) that can contribute to accurately predicting the user's emotions. More sensing modalities that are available will help provide more comprehensive physiological, cognitive, and environmental contexts and ultimately a more holistic picture of the user's emotional state.

The emotion service can reside locally as an application or reside in the cloud as a remote service. The emotion service can receive many different types of sensor data (including the prompt text) as inputs. The emotion service interacts with one or more machine-learning models, which can function as services. Each machine-learning model has a set of inputs that it takes and a set of outputs that it returns. The various machine-learning models can help each other learn and predict the user's emotions. Consistent with the present concepts, the emotion service outputs the predicted emotional states of the user.

Many different implementations are possible regarding the output of the emotion service. In one implementation, the emotion service outputs a set of real number values (e.g., normalized between 0 and 1) representing various levels of different emotion categories, for example, as a JavaScript Object Notation (JSON) array: {‘neutral’:0.1, ‘calm’:0.0, ‘happy’:0.6, ‘sad’: 0.0, ‘angry’: 0.2, ‘fearful’: 0.2, ‘disgust’:0.0, ‘surprised’:0.4}. This type of emotion vector is versatile in indicating the varying degrees of multiple emotion categories, some of which can overlap. Because no emotion is uniquely exclusive of other emotions (i.e., the user can experience multiple emotions at the same time), the output from the emotion service can include positive values for multiple emotion categories.

Alternatively, in another implementation, the emotion service outputs one integer representing the most prominent emotion selected from the following set: emotions={‘01’: (‘neutral’, 1), ‘02’: (‘calm’, 2), ‘03’: (‘happy’, 3), ‘04’: (‘sad’, 4), ‘05’: (‘angry’, 5), ‘06’: (‘fearful’, 6), ‘07’: (‘disgust’, 7), ‘08’: (‘surprised’, 8)}. For example, if the user is predicted as experiencing both happiness and nervousness at the same time, but the inferred degree of happy emotion is stronger than the inferred degree of nervous emotion, then the happiness emotion alone would be output by the emotion service. Alternatively, the emotion service output one or more integers representing one or more emotions whose degrees are above a certain threshold. For example, if the user is exhibiting both anger and disgust above a certain threshold level, then both of those emotion categories (anger and disgust) would be output by the emotion service.

In another implementation, the emotion service outputs one emotion category per sensing modality. Or, in another implementation, the emotion service outputs an emotion vector for each sensing modality. For example, if the user expresses a smile on his face but his voice sounds like he is annoyed, then the output from the emotion service can indicate that happiness emotion was inferred from the video modality whereas annoyed emotion was inferred from the audio modality.

In one implementation, the emotions that are output by the emotion service can include timestamp metadata that are determined based on the timestamps associated with the sensor data. Therefore, the timestamps can be used to precisely associate the emotion outputs from the emotion service to specific words in the original prompt.

The complete set of possible emotion categories and the possible levels of emotions can vary depending on how many possible emotions can be classified and output by the emotion service. Therefore, the output depends on the design and the training of the emotion service.

The emotion service can be further enhanced by personalizing it to the individual user. The machine-learning models can leverage information from previous contexts, such as from different users and different types of collected datasets, as well as leverage new datasets from the user's current context. That is, in addition to the offline training of the machine-learning models using the large datasets (e.g., CREMA-D, Emotion, and GoEmotions), the machine-learning models in the emotion service can be fine-tuned and personalized using datasets (e.g., audio, video, and other sensor data) gathered specifically from the user during runtime. The personalized machine-learning models can be adapted to the user's specific characteristics and, for example, can learn to normalize the user's voice, face, heart rate, body temperatures, etc.

In one implementation, the emotion service combines two predictions: one prediction by pre-trained models from data collected in a laboratory setting and another prediction by personalized models trained exclusively on the personal data collected from the user's current setting. The two predictions can be combined into one prediction output in several different ways, including aggregating, appending, averaging, maximum, minimum, weighting, etc. Therefore, the emotion service is better capable of understanding and interpreting, for example, the specific user's jokes, sense of humor, body language (e.g., gestures, posture, etc.), facial expressions, behavior (e.g., rolling eyes), speech pattern, word choice (e.g., dialect), vocal tones, heart rate, EEG signals, etc. Accordingly, the emotion service can be trained to be a personalized real-time empathic model that is fine-tuned to the specific user.

Additionally, in one implementation, the machine-learning models can continue to be fine-tuned during runtime using the ongoing sensor data. For instance, the machine-learning models can receive feedback on the quality of the emotion predictions (i.e., right or wrong emotional inferences) and adjust their weights accordingly. In some implementations, the machine-learning models can receive explicit feedback on the quality of their emotion predictions. For example, the user can be asked, “Are you happy?” or “Are you angry?” The user can respond, for example, with manual answers, such as, “Yes,” “No,” “A little bit,” or “Somewhat,” etc. The user's answers can serve as ground-truth labels for fine-tuning and/or personalizing the machine-learning models. Not a great number of labels are needed to accurately fine-tune and personalize the machine-learning models.

Alternatively or additionally, the user can be asked the quality of the conversation with the generative AI, such as “Is this helpful?” or “Did you find what you need?” Or, the user can be asked to rate the quality of the interaction, for example, using a brief five-star rating survey. Such explicit feedback from the user can be used to gauge whether the emotion service accurately inferred the user's emotional states.

Alternatively or additionally, less explicit and more automated techniques can be employed to improve the machine-learning models. That is, implicit feedback on the quality of the predicted emotions can be automatically obtained. For example, the machine-learning models can track the number of prompts the user needed to input to get the answer he needs, whether conversation sessions are longer or shorter, where the user rephrased the same/similar prompt multiple times, where the user's emotions directed to the generative AI are positive or negative (e.g., surprisingly satisfied at the responses versus frustration, disappointment, confusion, and anger), whether the user engages the generative AI more or less (i.e., the frequency of conversation sessions as well and the frequency trends), etc. These and many other passive feedback can be used to determine whether the machine-learning models are accurately inferring the user's emotions and whether the generative AI is returning context-appropriate responses.

### Prompt Augmentation

Consistent with the present concepts, the user's prompt is augmented using the context prediction made by the emotion service before the prompt is fed into the generative AI. There are many different possible techniques that the empathic prompting module can employ for enhancing the prompt to include and/or indicate the emotional states that are output from the emotion service. The different prompt augmenting techniques can vary in the amount of context information, the specificity of emotional states, format of the augmented prompt, etc. The specific technique employed for augmenting the prompt can depend on the content and format of the emotional states that are output from the emotion service and the content and format of the prompts (and of meta-prompts) that the generative AI can accept as inputs.

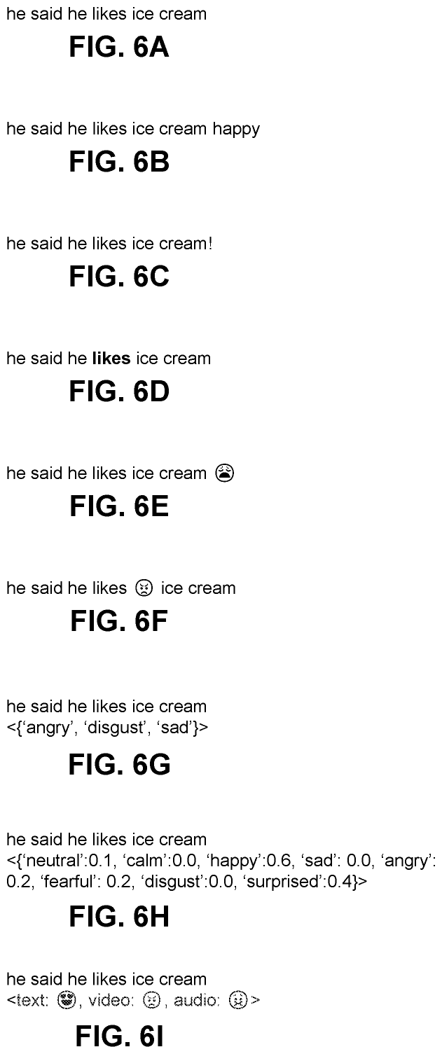

FIGS. 6A-6I illustrate example prompt augmentations, consistent with some implementations of the present concepts. Although various example techniques for incorporating the user's affective states into the prompts will be explained separately, these techniques can be used in combination.

FIG. 6A shows the example original prompt from FIGS. 1A and 1B. The original prompt includes the text “he said he likes ice cream.” The words in the original prompt (which may be broken up into tokens) are fed into the emotion service along with various sensor data in order to infer the emotional states of the user.

FIG. 6B shows an example augmented prompt. In this example, the emotion service interpreted the sensor data and predicted that the user is experiencing a happy emotion. Accordingly, consistent with one implementation of the present concepts, an additional token consisting of the word “happy” is appended to the original prompt to generate the augmented prompt shown in FIG. 6B. This is just one example. Many other variations are possible.

For example, if the emotion service outputs a value representing a different emotion, such as “sad” or “excited,” then the corresponding word can be appended to the original prompt. If the emotion service outputs a set of integers representing multiple emotions, then additional words for those emotions can be appended to the original prompt. If the emotion service outputs an emotion vector, then one or more emotion categories having a degree above a certain threshold can be appended to the original prompt.

FIG. 6C shows an example of a prompt that has been augmented using punctuation. In this example, the emotion service has determined that the user has expressed a strong emotion (e.g., any emotion category with a high level). The strong emotion can be positive or negative. Such a passion can be expressed by adding an exclamation point, as shown in the example augmented prompt in FIG. 6C, if the generative AI is capable of accepting and interpreting punctuations. Other techniques are possible. Multiple exclamation points can be added to express even stronger emotions, one or more questions marks can be added to indicate confusion, etc.

FIG. 6D shows an example augmented prompt that includes rich text. If the generative AI is capable of accepting and interpreting rich text, then the original prompt can be modified to include formatting. For example, if the emotion service determines that the user expressed a strong emotion while speaking the word “likes,” which can be determined using timestamps, then the empathic prompting module can highlight the word “likes,” as shown in FIG. 6D. Highlighting can involve bolding, italicizing, underlining, coloring, capitalizing, enlarging, etc. In one implementation, rich text formatting can be added using a markup language, for example, “<bold>likes</bold>.”

FIG. 6E shows an example augmented prompt that includes an emoji. If the generative AI can accept and interpret emojis, then the empathic prompting module can modify the original prompt by adding one or more emojis that correspond to the affective states output by the emotion service. For example, if the emotion service infers that the user was sad when speaking the prompt “he said he likes ice cream,” then the sad face emoji can be appended to the original prompt to generate the augmented prompt shown in FIG. 6E. The emoji token can be added as a graphical icon (emoji vector image), equivalent ASCII characters, a markup language tag, emoji character code (in decimal or hexadecimal number), etc.

FIG. 6F shows an example augmented prompt that includes an emoji inserted into the original prompt. In this example, an angry face emoji has been inserted at a point in time when the angry emotion was the strongest, as determined by the timestamps associated with the original prompt, the sensor data, and/or the emotions output by the emotion service. Alternatively, the angry face emoji can be inserted at a point in time when the angry emotion was first expressed (e.g., the degree of angry emotion exceeded a certain threshold).

In some implementations, the generative AI is capable of accepting metadata (e.g., meta-prompts) along with the original prompt. Therefore, the contextual information (e.g., emotion words, emojis, emotion vectors, etc.) can be input as metadata to the generative AI.

FIG. 6G shows an example augmented prompt that includes multiple emotion categories. In this example, the emotion service has inferred that the user is angry, disgusted, and sad while typing or speaking the original prompt. Accordingly, the empathic prompting module has augmented the original prompt with a set of the three inferred emotion categories. Depending on the capability of the generative AI, the set of emotion categories can be added in-line with the text of the original prompt (e.g., using a markup language), or the set of emotion categories can be input as metadata along with the original prompt to the generative AI.

FIG. 6H shows an example augmented prompt that includes an emotion vector. In this example, the emotion service has output an emotion vector (e.g., a set of normalized weights representing the degrees of various emotion categories). This output can be appended to the original prompt as a token or separately input as metadata to the generative AI.

FIG. 6I shows an example augmented prompt that includes an inferred emotion for multiple sensing modalities. In this example, the emotion service has output the most prominent emotion for each of three sensing modalities (text, video, and audio). Specifically, the text of the original prompt indicated that the user was happy, the video signals indicated that the user was angry, and the audio signals indicated that the user was disgusted. Accordingly, the empathic prompting module added the emotional states for the multiple sensing modalities to the original prompt.

As mentioned above, these example prompt augmentation techniques can be employed in combination, in varying degrees, and in varying precision. For example, the change to the original prompt can be as simple as appending one keyword or as complex and detailed as tagging every word in the original prompt with an emotion vector for each available sending modality.

As mentioned above, a null original prompt (i.e., an empty or blank prompt while the user is silent) can be augmented with the current emotional states of the user. This implementation can be especially useful where the generative AI is generating a verbose response and the user maintains silence while reading or listening to the verbose response. The emotion service can continue to output the latest emotional states of the user, and the empathic prompting module can continue to generate augmented prompts (consisting of only the context information but no original prompt) and feed the augmented prompts to the generative AI.

For example, augmented prompts without original prompts (i.e., with null original prompts) can be generated and sent to the generative AI periodically (e.g., every second, 10 second, or 30 seconds) or as needed when the user's emotional states change (e.g., a variance over a certain threshold). Therefore, the generative AI can receive real-time feedback from the user on the quality of the response and adjust accordingly. For example, if the response is causing the user to be bored, angry, disappointed, less attentive, etc., then the generative AI can modify the response, cut the conversation short, and/or interrupt the response to ask a question seeking feedback (e.g., “Is my answer helpful?”). Or, if the user's facial expression lights up when a specific term or topic is mentioned in the response, then the generative AI can generate more information about that specific term or topic in the rest of the response.

As another example, some conventional generative AI interfaces include a stop button that the user can activate to stop the generative AI's response. A similar function can be initiated by typing “stop” or speaking “stop.” In conventional scenarios, the generative AI does not know whether the response is positive or negative. That is, it is unclear if the user stopped the continued generation of the response because he already received the information he was seeking or because the response was unsatisfactory (e.g., unhelpful, irrelevant, or inappropriate). On the contrary, using the present concepts, the activation of the stop button (or a prompt consisting of the word “stop”) would be accompanied by contextual information (e.g., the emotional states of the user) in an augmented prompt, which would indicate whether the user is satisfied or dissatisfied with the response. Indeed, the present concepts could eliminate the need for a manual stop button, because the automated augmented prompts could alert the generative AI of the user's satisfaction or dissatisfaction with the response even before the user would activate such a stop button. Therefore, the generative AI can learn to recognize that it should stop generating the response automatically from the user's non-verbal cues alone.

In one implementation, the empathic prompting module uses rule-based algorithms to augment the original prompt based on the emotional states output by the emotion service. A set of rules can dictate how an output from the emotion service is translated and combined with an original prompt to generate an augmented prompt. For example, the rule-based algorithms can determine which additional tokens to add (e.g., emotion words, emojis, numbers representing emotions, etc.), the specific place in the original prompt to insert the contextual information (e.g., based on timestamps), and/or whether to add the contextual information to the metadata field, depending on the capabilities of the generative AI. For instance, one example rule can cause the empathic prompting module to translate a happy emotion output by the emotion service into a smiley emoji to be inserted into the original prompt.

Alternatively or additionally, in another implementation, the empathic prompting module uses one or more machine-learning models to learn and determine how to augment the original prompt using the output from the emotion service. The machine-learning models can be trained and fine-tuned using similar feedback discussed above to gauge the quality of the augmented prompts. For example, the machine-learning models can use emotion vectors that have different weights and can generate the contextual information portion of the augmented prompt. Moreover, the machine-learning models can learn over time which of the above-described prompt augmentation techniques (or which combinations) are most effective in accurately conveying the context information to the generative AI. Additionally, the machine-learning models can be specialized to work more effectively for a particular user, a particular emotion service, and/or a particular generative AI. Using machine-learning models for the empathic prompting module (and the emotion service) that can continue to evolve and adapt is especially beneficial, because the generative AI models in the field are continuing to evolve. A static, rule-based prompt generation engine that may perform well for one generative AI may not perform well with another generative AI. A flexible, machine-learning prompt generation engine can be more effective in working with new and changing generative AIs.

In some implementations of the present concepts, the generative AI (i.e., the LLM) is specifically trained to be context-aware (i.e., trained to accept and process the emotional context provided in the augmented prompts). That is, the training dataset used to develop the generative AI includes emotion indicators (e.g., emotion vectors, emotion emojis, emotion metadata, etc.).

Alternatively, in other implementations of the present concepts, even if the generative AI was not specifically trained to be context-aware, exposing the generative AI to augmented prompts that include contextual information based on emotions can cause the generative AI to eventually learn to become context-aware, because the generative AI is continuously learning. Over time, the generative AI will learn to understand the contextual information in the augmented prompts.

### Technical Advantages

The present concepts automatically infer the context relevant to the user's prompt, such as the user's emotional state, and automatically incorporate the context information into the prompt. Accordingly, the generative AI is automatically made aware of the user's emotions without requiring the user to manually verbalize contextual cues. Giving the generative AI the ability to automatically pick up on non-verbal cues from the user is a significant improvement that can make the conversation with generative AI more empathic and human-like.

Moreover, the present concepts can take advantage of many sensing modalities. In addition to audio and video signals, physiological, cognitive, environmental, and digital signals that can affect the user's emotional state can be leveraged to more accurately and more holistically infer the context. Indeed, the sensors and the emotion service are capable of detecting more context than humans can, including signals that humans generally cannot detect, such as heart rate, EEG signals, ECG signals, body temperature, etc.

Because augmented prompts enable the generative AI to be context-aware, the generative AI can understand the emotional context relating to the user's prompts and thus can generate more appropriate and relevant responses. This improves user experience, satisfaction, and engagement without requiring any additional effort from the user with respect to prompt design.

Furthermore, the concepts described herein (including the sensors, the interactive application, and the emotion service) can work with existing generative AIs as well as future generative AIs that will be developed. Implementing these concepts does not require redesigning or developing new generative AIs.

Developing generative AIs based on LLMs is costly and resource-intensive not only in hardware requirements but also in obtaining training datasets. Developing an all-in-one system (i.e., new LLMs and generative AIs that can detect sensor data, infer the user's affective states, and generate context-aware responses) that is personalized to each individual user is costly and unfeasible. However, the present concepts can provide the same benefits (i.e., a generative AI that can generate context-aware responses that are personalized to individual users) using existing or future generative AIs that are common to all users.

### Computer Environment

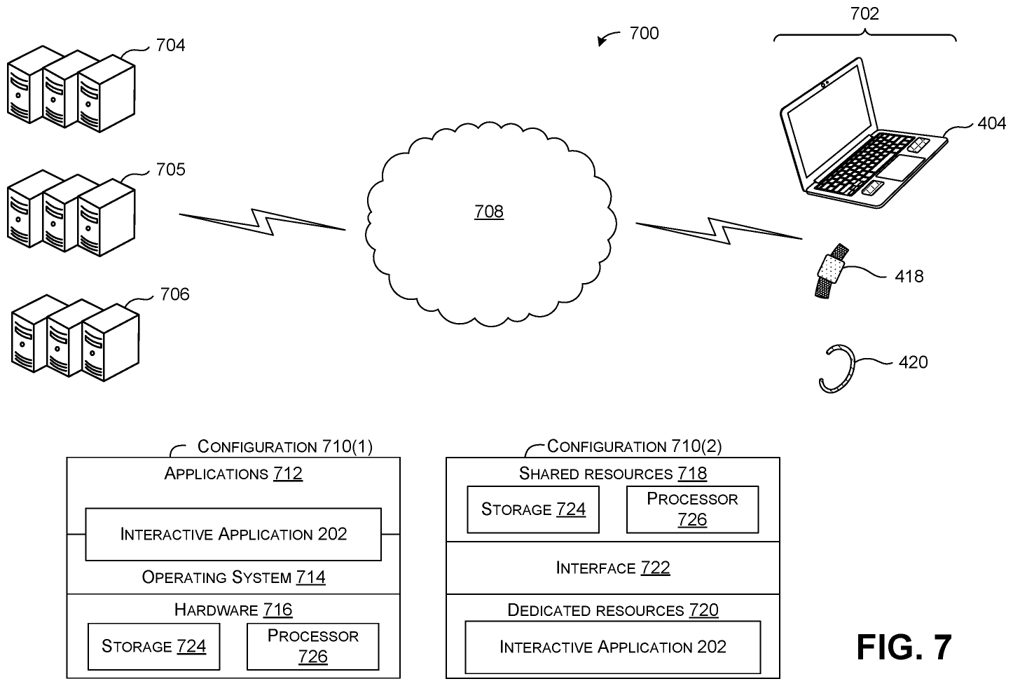

FIG. 7 illustrates an example computer environment 700, consistent with some implementations of the present concepts. The computer environment 700 includes sensors 702 for taking measurements and/or collecting sensor data associated with a user. For example, the laptop 404 includes a camera, a microphone, a keyboard, a touchpad, a touchscreen, an operating system, and applications. The laptop can capture video data (e.g., facial expression, pupil dilation, hand and arm gestures, etc.), audio data (e.g., speech, background noise, etc.), physiological data (e.g., heart rate), digital data (e.g., application focus, typing rate, clicking rate, scrolling rate, etc.), and/or environmental data (e.g., ambient light) associated with the user. The smartwatch 418 includes biosensors for capturing physiological data (e.g., heart rate, respiration rate, perspiration rate, motion activities, etc.). The EEG sensor 420 measures cognitive data (e.g., brain activity) of the user. The sensors 702 shown in FIG. 7 are mere examples. Many other types of sensors can be used to take various readings that relate to or affect the emotional state of the user.

The measured sensor data is transferred to an interactive application server 704 through a network 708. The users inputs a prompt via the laptop 404, and the laptop 404 sends the prompt to the interactive application server 704 via the network 708. The network 708 can include multiple networks (e.g., Wi-Fi, Bluetooth, NFC, infrared, Ethernet, etc.) and may include the Internet. The network 708 can be wired and/or wireless.

The interactive application server 704 takes the sensor data from the sensors 702 (and optionally performs pre-processing on the sensor data) and sends the sensor data to an emotion server 705 through the network 708. The emotion server 705 includes machine-learning models that predict the user's emotions based on the sensor data. The emotion server 705 transmits the predicted emotions to the interactive application server 704 through the network 708. The interactive application server 704 augments the prompt based on the predicted emotions and feeds the augmented prompt to a generative AI server 706 via the network 708. In turn, the generative AI server 706 transmits a response to the interactive application server 704, which then relays the response to the laptop 404 through the network 708 to be presented to the user.

In one implementation, each of the interactive application server 704, the emotion server 705, and the generative AI server 706 includes one or more server computers. These server computers can each include one or more processors and one or more storage resources. These server computers can serve different functions or can be load-balanced to serve the same or shared functions. The interactive application server 704, the emotion server 705, and the generative AI server 706 can be located on the same server computer or on different server computers. In one implementation, the interactive application server 704, the emotion server 705, and/or the generative AI server 706 run one or more services (e.g., cloud-based services) that can be accessed via application programming interfaces (APIs) and/or other communication protocols (e.g., hypertext transfer protocol (HTTP) calls). Although FIG. 7 depicts the interactive application server 704, the emotion server 705, and the generative AI server 706 as server computers, their functionality may be implemented on client computers, such as the laptop 404, a desktop computer, a smartphone, a tablet, etc.

FIG. 7 also shows two example device configurations 710 of a server computer, such as the interactive application server 704. The first device configuration 710(1) represents an operating system (OS) centric configuration. The second device configuration 710(2) represents a system on chip (SoC) configuration. The first device configuration 710(1) can be organized into one or more applications 712, an operating system 714, and hardware 716. The second device configuration 710(2) can be organized into shared resources 718, dedicated resources 720, and an interface 722 therebetween.

The device configurations 710 can include a storage 724 and a processor 726. The device configurations 710 can also include the interactive application 202.

As mentioned above, the second device configuration 710(2) can be thought of as an SoC-type design. In such a case, functionality provided by the device can be integrated on a single SoC or multiple coupled SoCs. One or more processors 726 can be configured to coordinate with shared resources 718, such as storage 724, etc., and/or one or more dedicated resources 720, such as hardware blocks configured to perform certain specific functionality.

The term “device,” “computer,” or “computing device” as used herein can mean any type of device that has some amount of processing capability and/or storage capability. Processing capability can be provided by one or more hardware processors that can execute data in the form of computer-readable instructions to provide a functionality. The term “processor” as used herein can refer to one or more central processing units (CPUs), graphical processing units (GPUs), controllers, microcontrollers, processor cores, or other types of processing devices, which may reside in one device or spread among multiple devices. Data, such as computer-readable instructions and/or user-related data, can be stored on storage, such as storage that can be internal or external to the device. The term “storage” can include any one or more of volatile or non-volatile memory, hard drives, flash storage devices, optical storage devices (e.g., CDs, DVDs etc.), and/or remote storage (e.g., cloud-based storage), among others. As used herein, the term “computer-readable medium” can include transitory propagating signals. In contrast, the term “computer-readable storage medium” excludes transitory propagating signals.

Generally, any of the functions described herein can be implemented using software, firmware, hardware (e.g., fixed-logic circuitry), or a combination of these implementations. The term “component” or “module” as used herein generally represents software, firmware, hardware, whole devices or networks, or a combination thereof. In the case of a software implementation, for instance, these may represent program code that performs specified tasks when executed on one or more processors. The program code can be stored in one or more computer-readable memory devices, such as computer-readable storage media. The features and techniques of the component are platform-independent, meaning that they can be implemented on a variety of commercial computing platforms having a variety of processing configurations.

### Additional Examples

Various examples are described above. Additional examples are described below. One example includes a computer-implemented method comprising receiving an original prompt from a user, receiving sensor data associated with the user, determining an emotional state of the user based on the sensor data, generating an augmented prompt by augmenting the original prompt based on the emotional state, inputting the augmented prompt to a generative artificial intelligence (AI), receiving a response from the generative AI, and outputting the response for presentation to the user.

Another example can include any of the above and/or below examples where the sensor data includes audio data, video data, physiological data, and cognitive data.

Another example can include any of the above and/or below examples where determining the emotional state comprises using a machine-learning model to classify the sensor data into emotion categories.

Another example can include any of the above and/or below examples where the emotional state includes one or more emotion categories.

Another example can include any of the above and/or below examples where the emotion state includes an emotion vector that indicates degrees of the emotion categories.

Another example can include any of the above and/or below examples where augmenting the original prompt comprises translating the emotional state of the user into at least a token and adding the token to the original prompt.

Another example can include any of the above and/or below examples where the token includes a word, a highlight, a punctuation, an emoji, a metadata, and/or an emotion vector.

Another example can include any of the above and/or below examples where generating the augmented prompt comprises using a machine-learning model to translate the emotional state to a token and adding the token to the original prompt.

Another example includes a system comprising a storage including instructions and a processor for executing the instructions to receive an original prompt including original tokens, receive sensor data, send the sensor data to an emotion service, receive an emotion from the emotion service, translate the emotion into an additional token, generate an augmented prompt by adding the additional token to the original token, and send the augmented prompt to a generative AI.

Another example can include any of the above and/or below examples where the sensor data includes a plurality of sensing modalities.

Another example can include any of the above and/or below examples where the emotion includes a plurality of emotion categories associated with the plurality of sensing modalities.

Another example can include any of the above and/or below examples where the emotion includes a plurality of emotion vectors associated with the plurality of sensing modalities.

Another example can include any of the above and/or below examples where the additional token includes the plurality of emotion vectors.

Another example can include any of the above and/or below examples where the original tokens are associated with first timestamps, the sensor data is associated with second timestamps, and the emotion is associated with third timestamps.

Another example can include any of the above and/or below examples where adding the additional token to the original prompt comprises inserting the additional token in a particular position among the original tokens based on the first timestamps, second timestamps, and/or the third timestamps.

Another example includes a computer-readable storage medium storing instructions which, when executed by a processor, cause the processor to receive sensor data, send the sensor data to an emotion service, receive an emotion from the emotion service, augment an original prompt based on the emotion to generate an augmented prompt, and send the augmented prompt to a generative AI.

Another example can include any of the above and/or below examples where the original prompt is blank.

Another example can include any of the above and/or below examples where the instructions further cause the processor to send a sequence of augmented prompts to the generative AI at regular intervals.

Another example can include any of the above and/or below examples where the emotion includes a number representing an emotion category.

Another example can include any of the above and/or below examples where the instructions further cause the processor to append a word that correlates with the emotion to the original prompt to generate the augmented prompt.

1. A computer-implemented method, comprising:
receiving an original prompt from a user;
receiving sensor data associated with the user;
determining an emotional state of the user based on the sensor data;
generating an augmented prompt by augmenting the original prompt based on the emotional state;
inputting the augmented prompt to a generative artificial intelligence (AI);
receiving a response from the generative AI; and
outputting the response for presentation to the user.

2. The computer-implemented method of claim 1, wherein the sensor data includes audio data, video data, physiological data, and cognitive data.

3. The computer-implemented method of claim 1, wherein determining the emotional state comprises:
using a machine-learning model to classify the sensor data into emotion categories.

4. The computer-implemented method of claim 1, wherein the emotional state includes one or more emotion categories.

5. The computer-implemented method of claim 4, wherein the emotion state includes an emotion vector that indicates degrees of the emotion categories.

6. The computer-implemented method of claim 1, wherein augmenting the original prompt comprises:
translating the emotional state of the user into at least a token; and
adding the token to the original prompt.

7. The computer-implemented method of claim 6, wherein the token includes a word, a highlight, a punctuation, an emoji, a metadata, and/or an emotion vector.

8. The computer-implemented method of claim 1, wherein generating the augmented prompt comprises:
using a machine-learning model to translate the emotional state to a token and adding the token to the original prompt.

9. A system, comprising:
a storage including instructions; and
a processor for executing the instructions to:
receive an original prompt including original tokens;
receive sensor data;
send the sensor data to an emotion service;
receive an emotion from the emotion service;
translate the emotion into an additional token;
generate an augmented prompt by adding the additional token to the original tokens; and
send the augmented prompt to a generative AI.

10. The system of claim 9, wherein the sensor data includes a plurality of sensing modalities.

11. The system of claim 10, wherein the emotion includes a plurality of emotion categories associated with the plurality of sensing modalities.

12. The system of claim 10, wherein the emotion includes a plurality of emotion vectors associated with the plurality of sensing modalities.

13. The system of claim 12, wherein the additional token includes the plurality of emotion vectors.

14. The system of claim 9, wherein:
the original tokens are associated with first timestamps;
the sensor data is associated with second timestamps; and
the emotion is associated with third timestamps.

15. The system of claim 14, wherein adding the additional token to the original prompt comprises:
inserting the additional token in a particular position among the original tokens based on the first timestamps, second timestamps, and/or the third timestamps.

16. A computer-readable storage medium storing instructions which, when executed by a processor, cause the processor to:
receive sensor data;
send the sensor data to an emotion service;
receive an emotion from the emotion service;
augment an original prompt based on the emotion to generate an augmented prompt; and
send the augmented prompt to a generative AI.

17. The computer-readable storage medium of claim 16, wherein the original prompt is blank.

18. The computer-readable storage medium of claim 16, wherein the instructions further cause the processor to send a sequence of augmented prompts to the generative AI at regular intervals.

19. The computer-readable storage medium of claim 16, wherein the emotion includes a number representing an emotion category.

20. The computer-readable storage medium of claim 16, wherein the instructions further cause the processor to append a word that correlates with the emotion to the original prompt to generate the augmented prompt.
